(19) United States
(12) Patent Application Publication
(10) Pub. No.: US 2005/0039214 A1
(43) Pub. Date: Feb. 17, 2005

(54) System and method for providing direct, context-sensitive customer support in an interactive television system

(76) Inventors: Kim E. Lorenz, Bellevue, WA (US); Mai-lan Tomsen, Seattle, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/790,216

(22) Filed: Feb. 21, 2001

(51) Int. Cl. H04N 7/173; H04N 7/16; H04N 5/445

(52) U.S. Cl. 725/105; 725/135; 725/37; 725/110; 725/109; 725/112

(57) ABSTRACT

In response to a customer pressing a specifically-designated button, the customer is placed in communication with a customer support center associated with the content currently being displayed by the customer's interactive television system. The interactive television system receives the request for customer support, identifies a support center associated with the content, and establishes a two-way communication channel between the support center and the customer. The two-way communication channel may support audio, video, text, and other data exchanges.

### BACKGROUND OF THE INVENTION

1. Field of the Invention

The present invention relates generally to the field of interactive television systems. More specifically, the present invention relates to a system and method for providing direct, context-sensitive customer support in an interactive television system.

2. Description of Related Background Art

Televisions and Internet technologies are beginning to converge. In particular, access to the World Wide Web via Internet-enabled television systems is becoming increasingly popular. Internet-enabled television systems bring the power of the Internet to a large segment of customers who were previously deterred by the complexities of modern personal computers.

However, the ability of content providers and makers of Internet-enabled television systems to attract and keep customers depends largely on the quality of customer support they provide. Typically, as customer support becomes more personal and responsive, customer satisfaction and loyalty increase proportionately.

Traditionally, providing high-quality customer support for a commercial Internet site has meant providing a toll-free telephone number and live support technicians. However, conventional telephone support has numerous drawbacks. For example, the customer must be able to describe to a support technician all of the symptoms of a problem he or she is experiencing. Moreover, without being able to observe the customer's display screen, the technician must be able to rapidly diagnose the problem and provide a list of clear, simple steps for the customer to follow to resolve the problem. Both of these requirements are hindered where the customer is not technologically savvy, as is the case with many people to whom Internet-enabled television systems are particularly appealing.

Telephonic support is also limited because a customer may not have convenient access to a telephone. Some Internet-enabled television systems require a telephone line to connect to the Internet. Therefore, to contact a customer support technician, the customer must disconnect from the Internet and then dial a customer support telephone number. However, without the Internet connection, the support technician is unable to walk the customer through the problem, such as asking the customer to perform different operations and report on the observed results.

Even more problematic is the fact that a customer may not know who to call to resolve a problem with an Internet-based application. For instance, the customer may know a general customer service telephone number for an Internet Service Provider (ISP). However, if the customers problem relates to the particular Internet content being displayed, calling the ISP would provide little or no benefit. Moreover, finding a telephone number for the content provider may require a tedious search of the content provider's site or printed instruction manuals.

Moreover, telephone-based customer support does not allow a support technician to directly control the customer's Internet-enabled television system, for instance, to demonstrate how an operation is performed or to fix a problem. Support technicians are often frustrated by a customer's inability to follow verbal instructions. Similarly, the customer and the support technician may become very frustrated as the problem described by the customer does not correspond to the expectations of the support technician.

Accordingly, what is needed is a system and method for providing direct, context-sensitive customer support related to content being displayed by an interactive television system. What is also needed is a system and method for providing direct, context-sensitive customer support which does not require the customer to know the address or phone number of the support center related to the content being displayed. Additionally, what is needed is a system and method for providing direct, context-sensitive customer support which does not rely on the primary telephone line of a customer. What is also needed is a system and method for providing direct, context-sensitive customer support which allows a customer to directly communicate with a support technician using audio, video, or text. What is also needed is a system and method for allowing a support technician to observe the content being displayed by the customer's interactive television system. Moreover, what is needed is a technique for allowing a customer support technician to control the customer's interactive television system, demonstrating particular operations or completing particular tasks for the customer.

### BRIEF DESCRIPTION OF THE DRAWINGS

Non-exhaustive embodiments of the invention are described with reference to the figures, in which:

FIG. 1 is a schematic block diagram of a system for delivering television programs and other forms of content;

FIG. 2 is an illustration of an interactive television system including a remote control, a keyboard, a set top box, and a television;

FIG. 3 is a schematic block diagram of physical components of a set top box;

FIG. 4 is a block diagram of a system for providing direct, context-sensitive customer support in an interactive television system according to an embodiment of the invention;

FIG. 5 illustrates a process of establishing a two-way communication channel between an interactive television system and a support center;

FIG. 6 illustrates a process of reserving a communication channel in a broadband communication network;

FIG. 7 illustrates a process of providing a copy of displayed content to a support center and receiving a command from the support center for execution on the interactive television system;

FIG. 8 is a user interface displaying the status of a customer's request for support; and

FIG. 10 is a flowchart of a method for providing direct, context-sensitive customer support in an interactive television system.

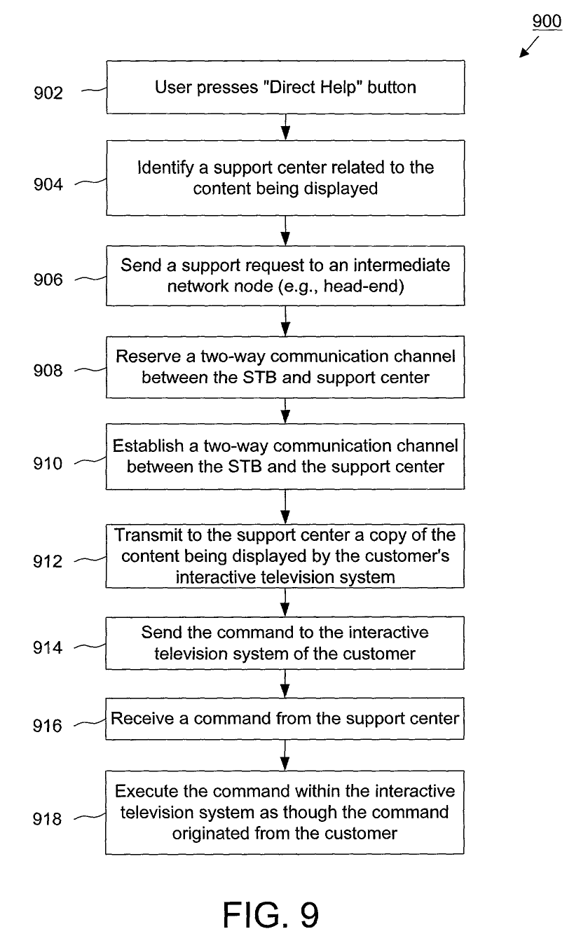

### DETAILED DESCRIPTION OF THE PREFERRED EMBODIMENTS

The present invention solves the foregoing problems and disadvantages with a system and method for providing direct, context-sensitive customer support related to content being displayed by an interactive television system. For example, in response to a customer pressing a specifically-designated button on a remote control, a two-way communication channel is established between the customer's interactive television system and a support center associated with the displayed content. Alternatively, the customer may activate a help icon or other control on a user interface (UI) displayed by the interactive television system in order to establish the two-way communication channel.

The two-way communication channel may be used for audio, video, text, commands, or a combination of these, depending on the capabilities of the support center and the customer's interactive television system. For example, a support center may support only text-based, “instant messaging” functionality. Alternatively, the support center may support full audio and video conferencing.

In one embodiment, a copy of the content being displayed to the customer is made available to the support center in order to assist a support technician in diagnosing the customer's problem. Moreover, in one configuration, a support technician may take control the customer's interactive television system in order to demonstrate the operation thereof, fix the customer's problem, etc.

As used herein, the term “customer” is not limited to users of a commercial Internet site. Rather, the term contemplates all users of interactive television systems, since every user is a potential customer of goods and services. For example, even users who access free services may be referred to as a customer.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

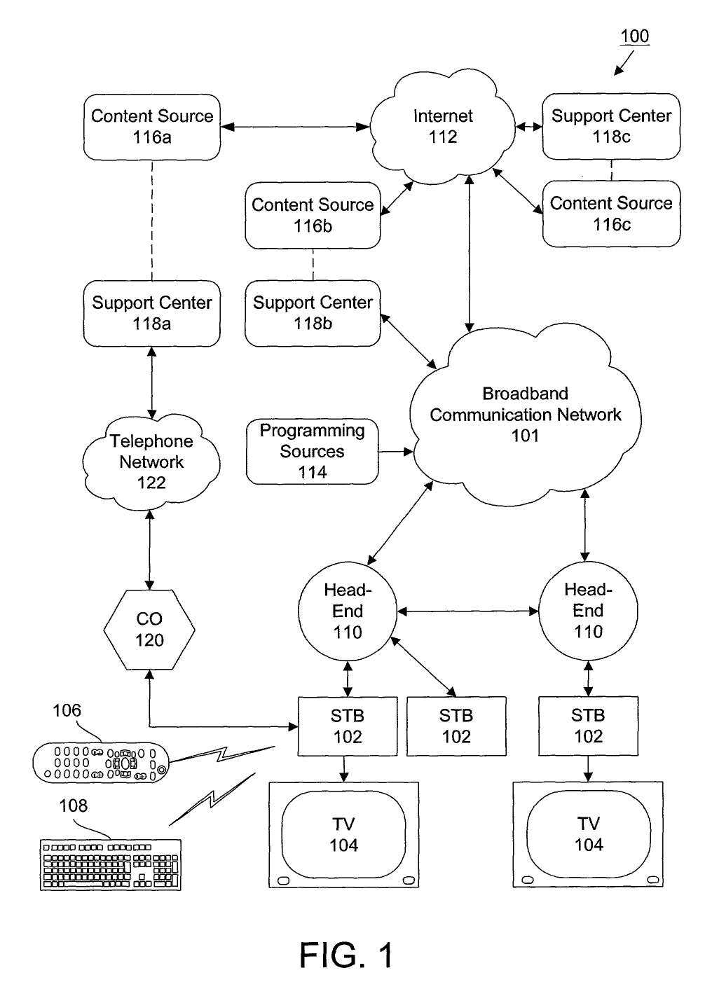

Referring now to FIG. 1, there is shown a system 100 for delivering television programs and other forms of content to a plurality of customers. In one implementation, the system 100 relies on a broadband communication network 101, such as a cable network. However, other networks are contemplated, one particular example of which is a satellite network.

In one configuration, the system 100 includes a plurality of set top boxes (STBs) 102 located, for instance, at customer homes. Generally, an STB 102 is a consumer electronics device that serves as a gateway between a customer's television 104 and the network 101. In alternative embodiments, an STB 102 may be embodied more generally as a personal computer, an advanced television 104, or another type of client terminal.

An STB 102 receives encoded television signals and other information from the network 101 and decodes the same for display on the television 104 or other display device (such as a computer monitor, flat panel display, or the like). As its name implies, an STB 102 is typically located on top of, or in close proximity to, the television 104.

Each STB 102 may be distinguished from other network components by a unique identifier, number, code, or address, examples of which include an IP (Internet Protocol) address or media access control (MAC) address. Thus, video streams and other information may be transmitted from the network 101 to a specific STB 102 by specifying the corresponding address, after which the network 101 routes the transmission to its destination using conventional techniques.

A remote control 106 is provided, in one configuration, for convenient remote operation of the STB 102 and the television 104. The remote control 106 may use infrared (IR), radio frequency (RF), or other wireless technologies to transmit control signals to the STB 102 and the television 104. Other remote control devices are also contemplated, such as a wired or wireless mouse (not shown).

Additionally, a keyboard 108 (either wireless or wired) is provided, in one embodiment, to allow the customer to rapidly enter text information into the STB 102. Such text information may be used for e-mail or instant messaging, e.g. text-based chat. In various embodiments, the keyboard 108 may use infrared (IR), radio frequency (RF), or other wireless technologies to transmit keystrokes to the STB 102.

In one embodiment, each STB 102 is coupled to the network 101 via a head-end 110 or other distribution center. In the context of a cable network, a head-end 110 is generally a centrally-located facility where television programs are received from a local cable TV (CATV) satellite downlink or other source and packaged together for transmission to customer homes. In one configuration, a head-end 110 also functions as a Central Office (CO) in the telephone industry, routing video streams and other data to and from the various STBs 102 serviced thereby. Head-ends 110 may be coupled directly to one another or through the network 101. In some cases, head-ends 110 may be connected via a separate network, one particular example of which is the Internet 112.

The network 101 is preferably coupled to one or more television programming sources 114, which provide television programming for distribution to the STBs 102. In one configuration, television programs are distributed in an encoded format, such as MPEG (Moving Picture Experts Group). Various MPEG standards are known, such as MPEG-2, MPEG-4, MPEG-7, and the like. Thus, the term “MPEG,” as used herein, contemplates all MPEG standards. Moreover, other video encoding/compression standards exist other than MPEG, such as JPEG, JPEG-LS, H.261, and H.263. Accordingly, the invention should not be construed as being limited only to MPEG.

The network 101 is also preferably coupled to the Internet 112 to provide access thereto by the STBs 102. The Internet 112 is a “network of networks” and is well known to those skilled in the art. Communication over the Internet 112 is accomplished using standard protocols, such as TCP/IP (transmission control protocol/Internet protocol) and the like.

In one embodiment, the Internet 112 is coupled to one or more content sources 116. A content source 116 provides access to various forms of content, such as Web pages, streaming media, databases, commercial transactions, and the like. For example, a content source 116 may include a commercial e-commerce site, such as Amazon.com®. The content sources 116 may be accessed, for example, using a Web browser integrated with an STB 102. Of course, content sources 116 may also be coupled directly to the network 101.

Preferably, each content source 116 is associated with a support center 118. A support center 118 is a facility staffed by support technicians who service requests for customer support. Broken lines in FIG. 1 indicate an affiliation or association between a content source 116 and a support center 118 and do not necessarily indicate a communication channel or physical proximity.

Each support center 118 may provide customer support for a particular company's products and/or services. For example, a cable operator (MSO) may provide a support center 118 for servicing support requests related to a CATV system. Another support center 118 may exist to help a customer in completing an on-line loan application or making an on-line purchase. While each content source 116 is depicted has having a unique support center 118, it is contemplated that a single support center 118 could service requests for customer support pertaining to more than one content source 116. In certain embodiments, a content source 116 may be located in close physical proximity to a support center 118, although this is not a requirement.

As explained in greater detail below, the remote control 106, keyboard 108, and/or STB 102 may be equipped with a microphone, video camera, and/or speaker to facilitate audio/video conferencing with a technician at a support center 118.

As illustrated, a support center 118 may be coupled to a customer's STB 102 in various ways to support two-way communication. In a first embodiment, an STB 102 is coupled to a support center 118a via a telephone company Central Office (CO) 120 and a telephone network 122, such as a public switched telephone network (PSTN). In such an embodiment, an STB 102 would typically establish an audio-only telephone connection between the customer and a support technician. However, video conferencing may also be provided in the case of higher-bandwidth digital telephone networks.

In a second embodiment, a support center 118b may be coupled to an STB 102 via a cable head-end 110 and the broadband communication network 101. In such an embodiment, the STB 102 converts analog audio/video data into a network-compatible audio/video stream and vice versa. Various protocols are contemplated for transmission of audio/video data over the network 101, such as MPEG, Voice over Broadband (VoB), and Voice over IP (VoIP).

In a third embodiment, a support center 118c may be coupled to an STB 102 via the Internet 112. In the depicted embodiment, the STB 102 also relies on the broadband network 101 to access the Internet 112, although the invention is not limited in this respect. Standards for communicating audio and video information over the Internet are well known to those skilled in the art.

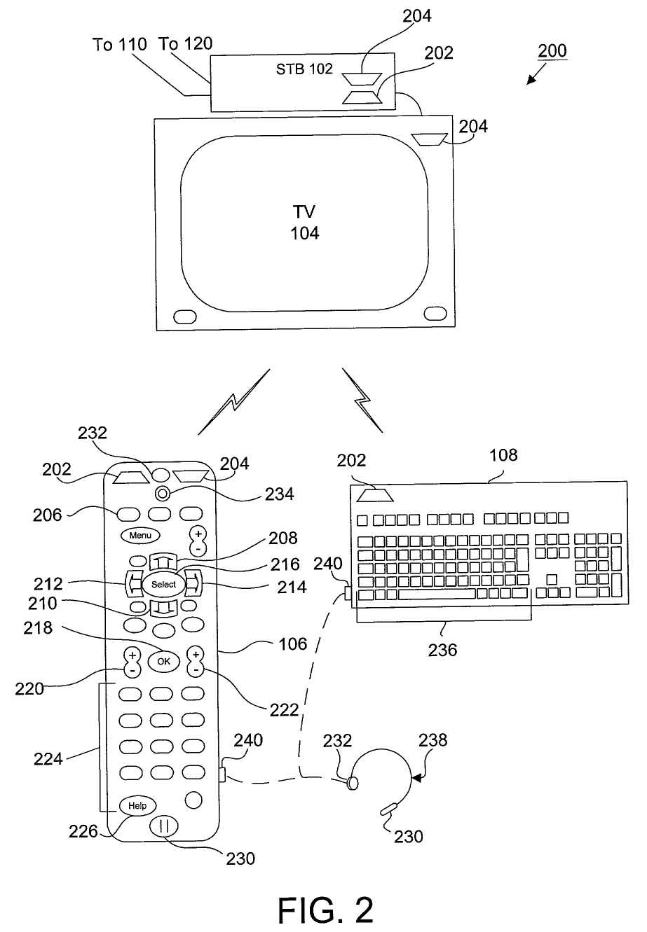

Referring now to FIG. 2, there is shown an interactive television system 200. In the depicted embodiment, the system 200 includes an STB 102, a television 104 (or other display device), a remote control 106, and, in certain configurations, a keyboard 108.

The remote control 106 is provided for convenient remote operation of the STB 102 and the television 104. In one configuration, the remote control 106 includes a wireless transmitter 202 for transmitting signals to the STB 102 and the television 104. Likewise, the remote control 106 includes a wireless receiver 204 for receiving signals from the STB 102.

In one embodiment, the wireless transmitters 202 and receivers 204 are configured to use radio frequency (RF) signals. In other embodiments, infrared (IR) or other frequencies along the electromagnetic spectrum may be used.

The remote control 106 preferably includes a number of buttons or other similar controls. For instance, the remote control 106 may include a power button 206, an up arrow button 208, a down arrow button 210, a left arrow button 212, a right arrow button 214, a “Select” button 216, an “OK” button 218, channel adjustment buttons 220, volume adjustment buttons 222, alphanumeric buttons 224, and a “Help” button 226. The operation of certain of the above-described buttons will be discussed in greater detail below.

To facilitate two-way communication with a support center 118, the remote control 106 includes, in one embodiment, a microphone 230 for capturing an audio signal. The captured audio signal is preferably transmitted to the STB 102 via the wireless transmitter 202. In addition, the remote control 106 may include a speaker 232 for generating audible output from an audio signal received from the STB 102. The audio signal is preferably received via the wireless receiver 204.

The various components of the remote control 106 may be positioned in different locations for functionality and ergonomics. For example, as shown in FIG. 2, the speaker 232 may be positioned near the “top” of the remote control 106 (when viewed from the perspective of FIG. 2) and the microphone 230 may be positioned at the “bottom” of the remote control 106. Thus, in one embodiment, a user may conveniently position the speaker 232 near the user's ear and the microphone 230 near the user's mouth in order to operate the remote control 106 in the manner of a telephone.

In alternative embodiments, as described below, the speaker 232, microphone 230, and/or the video camera 234 may be disposed within the STB 102, the keyboard 108, the television, and/or other suitable locations.

Alternatively or additionally, a hands-free headset 238 may be coupled to the remote 106 or keyboard 108. The headset 238 may include a microphone 230 and/or speaker 232. Such a headset 238 may be used to reduce audio interference from the television 104 (improving audio quality) and to provide the convenience of hands-free operation.

In one implementation, the wireless transmitter 202 is in electrical communication with the microphone 230 to receive the captured audio signal. The transmitter 202 preferably modulates the audio signal with a carrier frequency to enable transmission thereof to the STB 102 using techniques well known in the art. For example, the wireless transmitter 202 may operate according to the IEEE 802.11a or 802.11b Wireless Networking standards, the “Bluetooth” standard, or according to other standard or proprietary wireless techniques. Modulation techniques may include spread spectrum, frequency shift keying, multiple carrier, or other techniques known in the art.

To achieve modulation and transmission, the wireless transmitter 202 may include various additional components not specifically illustrated but well known in the art. For example, the wireless transmitter 202 may include a source encoder for reducing the amount of bandwidth required, a channel encoder to modulate the captured audio signal with a carrier signal, and a directional or non-directional transmission antenna. The antenna may comprise a substantially two-dimensional metal structure formed on the printed circuit board for the remote control 106. The wireless transmitter 202 may further include an amplifier to increase the transmission signal strength to an appropriate power level.

Likewise, the wireless receiver 204 may further include components not specifically illustrated but well known in the art. For example, the wireless receiver 204 may include an antenna for receiving a signal from the STB 102, an amplifier for increasing the strength of the received signal, and a decoder for separating and demodulating the data from the carrier signal.

In one embodiment, the wireless transmitter 202 and receiver 204 are configured to broadcast and receive digital signals. As such, the wireless transmitter 202 may include an analog-to-digital converter (ADC) for converting analog audio signals into digital data. Likewise, the wireless receiver 204 may include a digital-to-analog converter (DAC) to generate analog signals from digital data. The present invention contemplates both the use of analog and digital transmissions to and from the remote control 106.

In certain embodiments, the remote control 106 includes a video camera 234, such as a CCD (charge-coupled device) digital video camera. Where the support center 118 has the capability of receiving video signals, the video camera 234 allows the customer to capture and send video signals to a support technician. For example, the video camera 234 may capture images of the customer's screen to aid the technician at the support center 118 in resolving the customer's problem. In one implementation, the video camera 234 is in electrical communication with the wireless transmitter 202 for sending the captured video signal to the STB 102.

The keyboard 108, in certain embodiments, facilitates rapid composition of text messages. The keyboard 108 includes a plurality of standard alphanumeric keys 236 arranged in a suitable format, such as QUERTY or DVORAC. In one configuration, the keyboard 108 includes a wireless transmitter 202, similar or identical to the wireless transmitter 202 of the remote control 106. The wireless transmitter 202 transmits keystroke data from the keyboard 108 to the STB 102.

In the illustrated embodiment, the STB 102 includes an wireless receiver 204 (similar to the one in the remote control 106) for receiving control signals and audio/video signals from the remote control 106. Similarly, the STB 102 includes a wireless transmitter 202 (similar to the one in the remote control 106) for sending audio signals and other data to the wireless receiver 204 in the remote control 106.

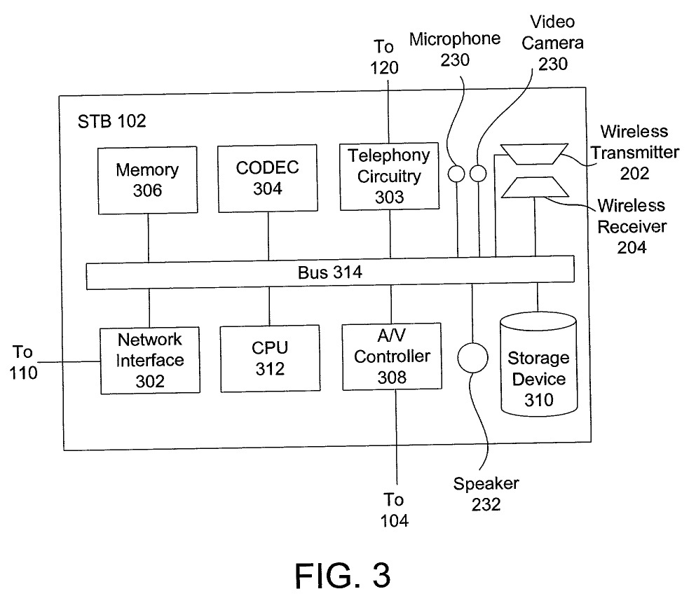

Referring now to FIG. 3, there is shown a physical block diagram of an STB 102 according to an embodiment of the invention. As noted above, the STB 102 includes a wireless receiver 204 for receiving control signals and audio/video signals sent by the wireless transmitter 202 in the remote control 106.

The STB 102 also includes, in one implementation, a network interface 302 for communicating with the broadband communication network 101 via the head-end 110. The interface 302 may include conventional tuning circuitry for receiving MPEG (Moving Picture Experts Group) packets for a selected television channel. The interface 302 may also include conventional cable modem circuitry for sending or receiving other types of data. For example, the interface 302 may conform to the DOCSIS (Data Over Cable Service Interface Specification) or DAVIC (Digital Audio-Visual Council) cable modem standards. In one embodiment, a CMTS-DRFI (Cable Modem Termination System-Downstream RF Interface) may be used in conjunction with a CMTS-URFI (Cable Modem Termination System-Downstream RF Interface) to establish two-way communication between the STB 102 and the head-end 110.

In one configuration, one or more frequency bands (for example, from 5 to 30 MHz) may be reserved for upstream transmission. Digital modulation (for example, quadrature amplitude modulation or vestigial sideband modulation) may be used to send digital signals in the upstream transmission. Of course, upstream transmission may be accomplished differently for different networks 101. Alternative ways to accomplish upstream transmission include using a back channel transmission, which is typically sent via an analog telephone line, ISDN, DSL, or other techniques.

In an embodiment in which the STB 102 is configured to access a support center 118 via a telephone network 122, the STB 102 includes standard telephony circuitry 303. The telephony circuitry 303 may be used to dial a telephone number and establish a two-way telephone connection between the STB 102 and a support center 118.

In one embodiment, the telephony circuitry 303 transforms an audio signal received by wireless receiver 204 of the STB 102 into a telephony-grade audio signal for transmission via the telephone network 122. Likewise, the telephony circuitry 303 may receive a telephony-grade audio signal from the telephone network 122 and generate an audio signal compatible with the wireless transmitter 202 of the STB 102 for transmission to a speaker 232 in the remote control 106, STB 102, or the television 104. Alternatively, or in addition, the telephony circuitry 303 may include analog or digital (e.g. DSL) modem circuitry to allow audio, video, text, and control data to be transmitted to the support center 118 via the telephone network 122.

The STB 102 also preferably includes a CODEC (encoder/decoder) 304. The CODEC 304 serves to encode signals (such as audio/video signals) into a network-compatible data stream for transmission over the network 101. The CODEC 304 also serves to decode a network-compatible data stream received from the network 101. As depicted, the CODEC 304 may be implemented as a hardware component. Alternatively, or in addition, software encoding and decoding may be used. The CODEC 304 may use various algorithms, such as MPEG, for encoding and decoding.

The STB 102 further includes a memory device 306, such as a random access memory (RAM), configured to store data for temporary use. Similarly, a read-only memory (ROM) may be provided for storing more permanent data, such as fixed code and configuration information.

In one embodiment, an audio/video (A/V) controller 308 is provided for converting decoded digital audio/video information into analog signals for display/playback on the television 104 or other device or devices. The A/V controller 308 may be implemented using one or more physical devices, such as a separate graphics and sound cards. In alternative embodiments, the A/V controller 308 may provide a direct, digital video output for televisions 104 or other devices equipped to receive the same. Preferably, the A/V controller 308 includes graphics hardware for performing bit-block transfers (bit-blits) and other graphical operations.

In some implementations, the STB 102 may include a storage device 310, such as a hard disk drive or the like. The storage device 310 may be configured to record encoded television broadcasts and retrieve the broadcasts at a later time for decoding by the CODEC 304 and display by the A/V controller 308.

The storage device 310 may also be used in various embodiments to store viewer preferences, parental lock settings, electronic programming guide (EPG) data, programming preferences, passwords, e-mail messages, and the like. In one implementation, the storage device 310 also stores an operating system (OS) for the STB 102, such as Windows CE® or Linux®.

A CPU 312 controls the operation of the STB 102, including the other components thereof, which are coupled to the CPU 312 via a bus 314. The CPU 312 may be embodied as a microprocessor, a microcontroller, a digital signal processor (DSP) or other device known in the art. As noted above, the CPU 312 may perform logical and arithmetic operations based upon control signals generated by the remote control 106 and transmitted to the receiver 204. Alternatively, the CPU 312 may respond to control signals received through the network interface 302.

As noted above, the STB 102 may include, in certain embodiments, a microphone 230, speaker 232, and/or video camera 234 for capturing and reproducing audio and/or video signals. These components may be included in lieu of or in addition to similar components in the remote control 106, keyboard 108, and/or television 104.

Of course, FIG. 3 illustrates only one possible configuration of an STB 102. Those skilled in the art will recognize that various other architectures and components may be provided within the scope of the invention. In addition, various standard components of typical STB 102 are not illustrated in order to avoid obscuring aspects of the invention.

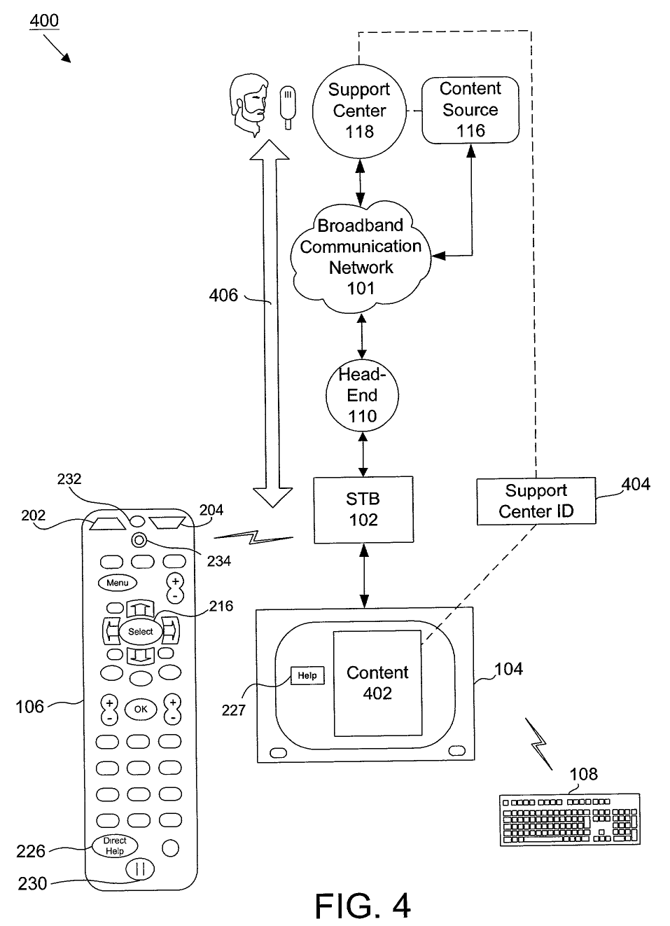

FIG. 4 is a schematic block diagram of a system 400 for providing direct, context-sensitive customer support in an interactive television system 200 that resolves the above-described problems and disadvantages of conventional systems. As explained more fully hereafter, the depicted system 400 allows a customer to request customer support for currently displayed content 402 and engage in two-way audio/video communications or text chat with a technician at a support center 118 associated with the displayed content 402.

In one embodiment, a support center 118 is equipped with an interactive television system 200 of the type illustrated in FIG. 2. Alternatively, a support center 118 may include a personal computer or the like having similar functionality.

Suppose the customer is about to purchase a purchase a book on an e-commerce site, such as Amazon.com®. However, the customer is having difficulties in redeeming an electronic coupon. The site insists that the coupon has already been used, but the customer knows this not to be the case.

Traditionally, the customer would need to find a customer support section within the site, make a note of the customer support number, and place a call to that number. In some cases, the customer would need to disconnect from the Internet 112 in order to obtain access to a telephone line.

By contrast, in accordance with an embodiment of the invention, the user simply presses a “Direct Help” button 226 or the like on the remote control 106. Alternatively, the “Direct Help” button 226 may be embodied as a selectable help icon 227 or the like on the television 104. In such an embodiment, the appearance of the help icon 227 on the television 104 may be an indication that customer support is available for the content 402 being displayed.

In response to activation of the “Direct Help” button 226, the wireless transmitter 202 of the remote control 106 sends an appropriate control signal to the STB 102. Upon receiving the control signal, the STB 102 identifies a support center 118 associated with the content 402 being displayed. In an alternative embodiment, identification of the support center 118 may occur at the head-end 110 or another location within the network 101.

In one implementation, the support center 118 is identified by locating a support center identifier (ID) 404 associated with the displayed content 402. In the illustrated embodiment, the broken lines indicate a relationship between the content 402, a support center identifier 404, a support center 118, and a content source 116 (such as a financial Web site).

The support center ID 404 may include, for example, a network address. The type and format of the network address depends on the particular network (e.g., Internet 112, broadband network 101, or telephone 122) used by the STB 102 to establish a two-way communication channel with the support center 118. For example, if the Internet 112 is to be used, the network address may be embodied as uniform resource locator (URL) or an Internet protocol (IP) address. If the broadband network 101 is used, the network address may correspond to a media access control address (MAC) or the like. If the telephone network 122 is used, then the network address may be embodied as a telephone number. In certain embodiments, a plurality of network addresses may be provided where more than one type of network connection may be available.

In one configuration, the support center ID 404 is encoded with the content 402. For example, where the content 402 is encoded in a markup language, such as XML (extensible markup language), the support center ID 404 may be embodied as a custom tag, e.g. “<supportctrlD>www.quicken.com</supportctrlD>.” Such custom tags would typically not be displayed with the content 402, but would provide an easy mechanism for identifying the support center 118 associated with the displayed content 402.

After the support center ID 404 is located, a two-way communication channel 406 is established between the support center 118 and the user's STB 102. The process for establishing the two-way communication channel 406 varies depending on underlying network. For example, in the case of a purely audio connection using the network 101, the STB 102 may request that the head-end 110 reserve a two-way communication channel 406. Thereafter, an audio signal is captured by a microphone 230 (not shown) at the support center 118, converted into a network-compatible audio stream (by the CODEC 304), and transmitted over the two-way communication channel 406 to the customer's STB 102 and/or remote control 106 for playback on a speaker 232.

Simultaneously, an audio signal is captured by a microphone 230 in the customer's remote control 106 or STB 102, converted into a network-compatible audio stream, and transmitted over the two-way communication channel 406 to the support center 118 for playback on a speaker 232 (not shown). In this manner, two-way audio conferencing is enabled between the customer and a technician at the support center 118.

Where both the support center 118 and the customer's interactive television system 200 include a video camera 234 and a display device (such as a television 104), the system 400 may also be used for video conferencing. Captured video signals may be converted into network-compatible video streams and sent over the two-way communication channel 406 for display on corresponding televisions 104 or other display devices.

Where audio and video conferencing is not available or desired, text data originating from a keyboard 108 (not shown) at the support center 118 may be sent over the two-way communication channel 406 to the customer's STB 102 and displayed on the customer's television 104 or other display device. In return, text data originating from the customer's keyboard 108 may be sent over the two-way communication channel 406 to the support center 118 and displayed on a television 104 or other display device.

Thus, in one embodiment, the two-way communication channel 406 provide a medium for exchanging text messages in the form of e-mail or “instant” messages. Instant messaging is essentially a full-duplex, text-based chat session in which keystrokes of one user are echoed on the display device of another user. Instant messaging functionality is advantageous where the support center 118 does not have the capability of audio/video conferencing. E-mail functionality is useful, for example, where the support center 118 is not staffed 24 hours a day. Various e-mail clients are known, such as Microsoft Outlook@. Likewise, various instant messaging clients are known, examples of which include AOL Instant Messenge®, and MSN® Messenger Service.

In the context of text-based communication, the support center ID 404 may include an e-mail address, user name, “handle,” or other identifier used by the particular e-mail client or instant messaging client. Various e-mail protocols are known, such as SMTP (simple mail transfer protocol), POP (post office protocol), and IMAP (Internet message access protocol). Instant messaging protocols vary according to the particular client application being used.

In one implementation, activating the “Direct Help” button 226 is the only user action necessary for establishing a two-way communication channel 406 with a support center 118. In alternative embodiments, the user may navigate a series of menus, icons, or other user interface controls. For example, as shown in FIG. 4, a user interface (UI) for an interactive television system 200 may include a help icon 227. A user may activate the help icon 227, in one embodiment, by using the navigational (arrow) buttons and the “Select” button 216 of the remote control 106. Activating the help icon 227 is equivalent to pressing the “Direct Help” button 226 in one embodiment.

The help icon 227 may be configured in various ways to provide easy recognition of the same. For example, the help icon 227 may appear in the shape of a telephone, question mark, human mouth, or other suitable form.

As noted above, the help icon 227 may be displayed whenever a support center 118 is available for the displayed content 402. For example, where the content 402 includes or is associated with a support center ID 404, the help icon 227 may be displayed.

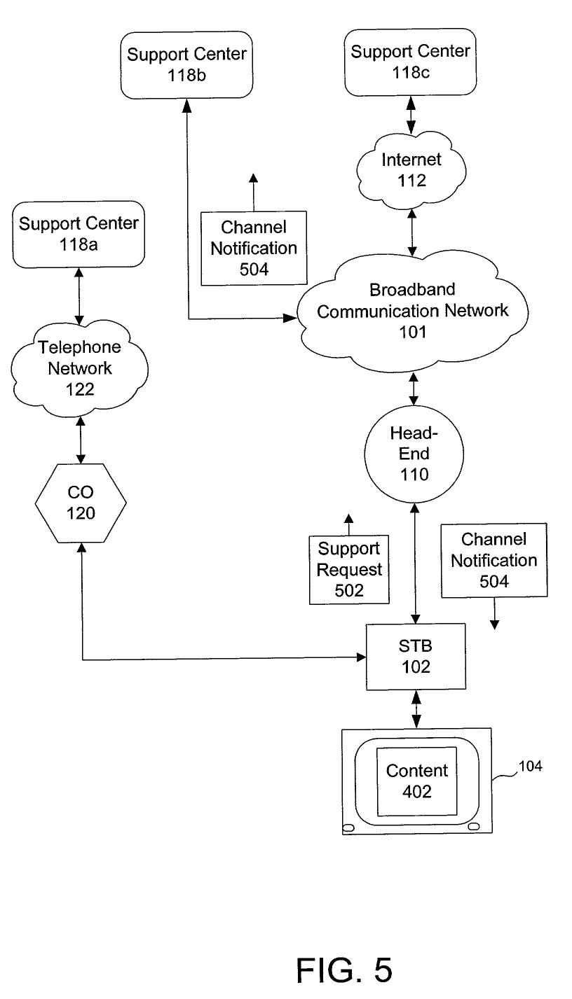

FIG. 5 provides additional details concerning the process of establishing a two-way communication channel 406. Whether the STB 102 is coupled to the support center 118 via a telephone network 122, broadband network 101, or the Internet 112, the process begins by sending a support request 502 to an intermediate network node, such as a CO 120, a head-end 110, or an Internet server.

For example, in the case of a telephone network 122, the support request 502 may include a signal representing a telephone number. The format of the support request 502 is not crucial to the invention, although it should identify the support center 118 (possibly by its network address) and may additionally identify the customer's STB 102.

In response to the support request 502, the intermediate network node reserves or assists in reserving the two-way communication channel 406. In one embodiment, this is done by sending a channel notification 504 to the support center 118 and the STB 102. In the case of a telephone network 122, the channel notification 504 may take the form of a signal indicating that a telephone connection has been established.

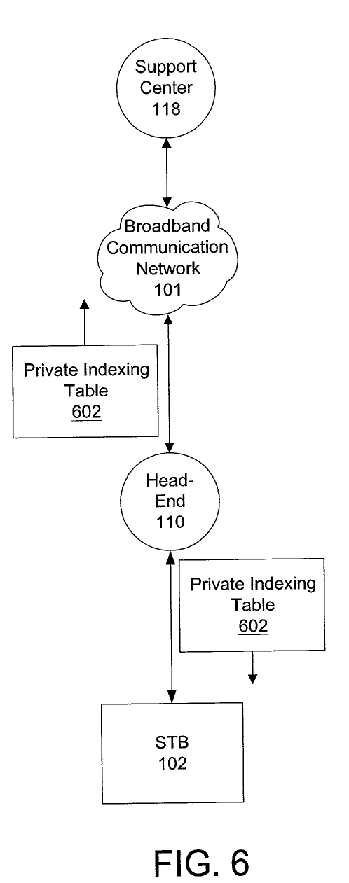

In the context of a broadband network 101, as shown in FIG. 6, the channel notification 504 may take the form of a private indexing table 602, which indicates PID (packet identifier) assignments for MPEG channels. In one embodiment, an available MPEG channel is selected at head-end 110 and assigned a PID. A private indexing table 602 is updated to indicate that the selected MPEG channel is to be used for the two-way communication channel 406. Thereafter, the private indexing table 602 is sent to both the support center 118 and the STB 102, such that each knows which MPEG channel to use for communication.

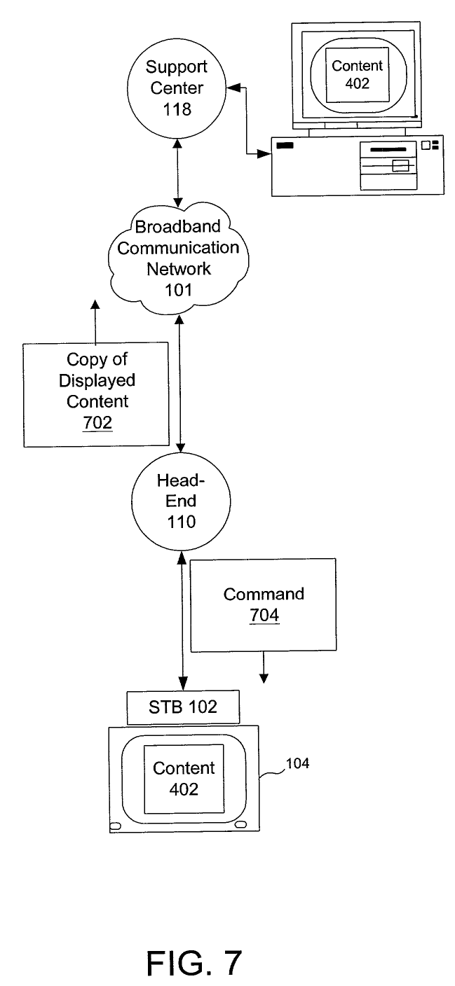

FIG. 7 illustrates two additional features of the present invention. As previously noted, one of the difficulties in providing quality customer support is the technician's inability to see the content 402 being displayed to the customer. Another difficulty is that the technician may not normally control the customer's interactive television system 200, but must rely on the customer to execute often complex instructions to resolve a problem.

In one embodiment, a copy 702 of the content 402 being currently displayed by the customer's television 104 is sent to the support center 118 for presentation to the support technician on a television 104, computer monitor, or the like. The copy 702 may be generated, for instance, by the STB 102 using various techniques. For example, where the STB 102 is displaying an HTML (hypertext markup language) document, the STB 102 may send a copy of the HTML document to the support center 118.

In an alternative embodiment, the STB 102 may send one or more screen shots (or captures) of the currently displayed content 402. A screen shot is an image of the content 402 displayed on the customer's television 104, and may be stored as a bitmap, compressed image (JPEG), or the like. The screen shot may be obtained from a frame buffer or the like managed by the A/V controller 308.

In yet another alternative embodiment, the STB 102 may rely on “thin client” technology, such as Citrix®, to send screen updates to the support center 118. Such technologies intercept low-level hardware commands to a display controller and send copies of those commands to a display controller of another computer.

Alternatively, or in addition, the head-end 110 may be involved in sending a copy 702 of the displayed content 402 to the support center 118. For example, where the head-end 110 is sending video content 402, such as a television program, to the STB 102, it is more efficient for the head-end 110 to send a copy 702 of the video content 402 to both the STB 102 and the support center 118.

In one embodiment, the STB 102 may send information about the customer's button presses, keystrokes, menu selections, and the like, to the support center 118. Information about the customer's inputs and actions is sometimes important in resolving a problem.

Likewise, in one implementation, commands 704 initiated by a support technician are sent from the support center 118 to the STB 102 and executed as though they were performed by the user. This allows the technician to remotely operate the customer's STB 102 in order to demonstrate operations, enter data, change configuration settings, and the like. Remote operation may be desirable where the customer's problem is very complicated, or commands or configuration data must be entered which the support technician does not desire the customer to execute. The commands 704 may include the technician's keystrokes, button presses, mouse events, menu selections, and the like. Again, thin-client technology, such as Citrix®, may be used to relay commands 704 from the support center 118 to the STB 102.

Of course, various security protocols may be implemented, such as requiring customer authorization before a support technician may receive the copy 702 of the displayed content 402 or be able to issue commands 704 to the customer's STB 102. In addition, the copy 702 may include sections which conceal sensitive information from the support technician. This information may include, for example, credit card numbers, social security numbers, personal telephone numbers, passwords, keys, and the like. In this manner, the customer receives support without a loss of privacy. Additionally, the copy 702 of the customers screen, support center commands 704, and the audio and video information transmitted across the communication channel 406 may be encrypted to protect against unauthorized access to the information. This may be particularly useful where the two-way communication channel 406 includes the Internet 112.

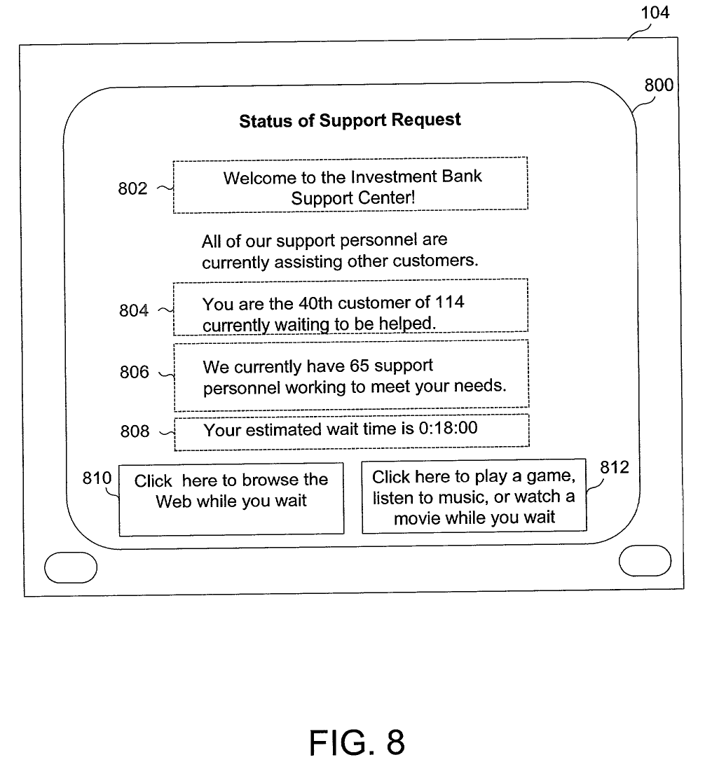

Often, a support center 118 will have fewer support technicians than is necessary to immediately service every support request. Thus, a user may have to wait for a period of time before communicating with a support technician. FIG. 8 illustrates an embodiment of a user interface (UI) 800 displayed on a television 104 (or other display device) while the user is waiting to communicate with a technician.

In one embodiment, the UI 800 may include an indication 802 of the support center 118 handling the support request. This is advantageous because it allows a user to immediately determine whether he or she is waiting for the correct support technician.

Additionally, the UI 800 may include an indication 804 of the number of users waiting a support queue, and the customer's place in the support queue. Typically, support centers 118 are managed on a first come, first serve basis. However, in some cases, priority for servicing a support request may be based on the level of service paid for by a user.

Moreover, the UI 800 may include an indication 806 of the total number of support personnel working to service support requests. It may be comforting to a user, for example, when noting the she is the 40^{th} customer in line, to know that there are 65 support personnel working to service support requests.

The UI 800 may also include an indication 808 of an estimated wait time. The indication 808 may be based upon the number of users with a higher support priority and the typical amount of time required to service a support request.

The above-described information provided by the UI 800 may greatly increase a customer's willingness to wait for customer support. To even further alleviate a customer's frustration while waiting for service, a button 810 may be provided, which, when activated, allows the user to browse the Web while waiting for customer support. In one embodiment, the UI 800 is temporarily replaced by a Web browser interface (not shown). When a support technician is available, the Web browser interface may be replaced by UI (not shown) configured to allow two-way communication between the user and the support technician.

In one embodiment, an additional button 812 is provided, which, when activated, provides a UI (not shown) that allows a user to listen to music, watch a movie, or even play a game. Such distractions greatly alleviate a customer's frustration where he or she must wait for a considerable period of time.

Referring now to FIG. 9, there is shown a flowchart a method 900 for providing direct, context-sensitive customer support in an interactive television system 200. The method 1000 begins when the customer presses 902 a “Direct Help” button 226 on a remote control 106, activates a help icon 227, or otherwise requests customer support.

A support center 118 is then identified 904 that corresponds to the content 402 being displayed by the customer's television 104. Thereafter, a support request is sent 906 to an intermediate network node, such as a head-end 110. In one embodiment, the intermediate network node reserves 908 and establishes 910 two-way communication channel 406 between the STB 102 and the support center 118. The communication channel 406 may be used for audio signals, video signals, text messages, commands, or a combination of these.

In one embodiment, the STB 102 (and/or head-end 110) transmits 912 a copy 702 of the content 402 being displayed to the support center 118. Where appropriate, the support center 118 may send 914 a command 704, which is received 916 and executed 918 by the STB 102 as though it were initiated by the customer.

Based on the foregoing, the present invention offers numerous advantages not available in conventional approaches. For example, the present invention allows the customer to request customer support by performing a single action, such as pressing the “Direct Help” button 226. In addition, the customer need not know how to contact a particular support center 118. Identifying and contacting of a support center 118 is handled automatically through the inclusion of a support center ID 404 with the content 402.

In certain embodiments, a support technician may receive a copy 702 of the content 402 being displayed by the customer's television 104. This allows for rapid and accurate determination of the customer's problem. Moreover, in certain implementations, a support technician may be enabled to issue commands to the customer's STB 102, which are executed as though the commands originated with the customer. This allows for rapid resolution of the customer's problem.

While specific embodiments and applications of the present invention have been illustrated and described, it is to be understood that the invention is riot limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

1. A method for providing context-sensitive customer support in an interactive television system, the method comprising:
receiving from a user a request for customer support;
identifying a support center related to content being displayed by the interactive television system; and
establishing a two-way communication channel between the interactive television system and the support center.

2. The method of claim 1, wherein the request is received in response to a single user action.

3. The method of claim 2, wherein the single user action comprises activation of a specifically-designated button on a remote control device for the interactive television system.

4. The method of claim 2, wherein the single user action comprises activation of a specifically-designated control displayed on a user interface for the interactive television system.

5. The method of claim 1, further comprising:
visually indicating when customer support is available for the content being displayed by the interactive television system.

6. The method of claim 5, wherein visually indicating comprises:
displaying an icon on a user interface for the interactive television system.

7. The method of claim 1, wherein the content being displayed includes a support center identifier, and wherein identifying comprises:
reading the support center identifier from the displayed content.

8. The method of claim 7, wherein the support center identifier comprises a network address.

9. The method of claim 8, wherein the network address comprises one of a uniform resource locator (URL), an Internet protocol (IP) address, a telephone number, and a media access control (MAC) address.

10. The method of claim 1, wherein the interactive television system comprises a microphone for capturing an audio signal for transmission to the support center and a speaker for generating audible output from an audio signal received from the support center.

11. The method of claim 10, wherein the microphone is integrated with a remote control device for the interactive television system.

12. The method of claim 10, wherein the microphone is integrated with a set top box for the interactive television system.

13. The method of claim 10, wherein the speaker is integrated with a remote control device for the interactive television system.

14. The method of claim 10, wherein the speaker is integrated with one of a set top box and a television for the interactive television system.

15. The method of claim 1, wherein the interactive television system comprises a video camera for capturing a video signal for transmission to the support center.

16. The method of claim 15, wherein the video camera is integrated with a remote control device for the interactive television system.

17. The method of claim 15, wherein the video camera is integrated with a set top box for the interactive television system.

18. The method of claim 1, wherein establishing comprises:
establishing a text-based, instant messaging session between the interactive television system and the support center.

19. The method of claim 1, wherein establishing comprises:
sending a support request to an intermediate network node;
reserving a communication channel at the intermediate network node, wherein the communication channel is configured to permit two-way communication between the user and the support center; and
notifying the interactive television system and the support center of the reserved communication channel.

20. The method of claim 19, wherein the intermediate network node comprises a head-end of a broadband communication network.

21. The method of claim 19, wherein the intermediate network node comprises a central office (CO) of a telephone network.

22. The method of claim 19, wherein the communication channel comprises a Moving Picture Experts Group (MPEG) channel.

23. The method of claim 22, wherein reserving comprises:
selecting an available MPEG channel for use as the communication channel;
updating a private indexing table to indicate the selected MPEG channel; and
sending the private indexing table to the support center and the interactive television system.

24. The method of claim 1, wherein establishing comprises:
displaying on the interactive television system a status indication pertaining to the support request.

25. The method of claim 24 wherein the status indication comprises at least one of:
an indication of a wait time;
an indication of the user's priority in a support queue;
an indication of a number of users in a support queue; and
an indication of a number of support technicians servicing customer support requests.

26. A system for providing context-sensitive customer support comprising:
a remote control device for an interactive television system configured to detect a user request for customer support; and
a set top box for the interactive television system configured to identify a support center related to content being displayed by the interactive television system and to establish a two-way communication channel between the user and the support center.

27. The system of claim 26, wherein the user request for customer support comprises a single user action.

28. The system of claim 27, wherein the single user action comprises activation of a specifically-designated button of the remote control device to request customer support.

29. The system of claim 27, wherein the single user action comprises activation of a specifically-designated control displayed on a user interface for the interactive television system.

30. The system of claim 26, wherein the set top box is further configured to display a visual indication when customer support is available for the content being displayed by the interactive television system.

31. The system of claim 30, wherein the visual indication comprises an icon displayed on a user interface for the interactive television system.

32. The system of claim 26, wherein the content being displayed includes a support center identifier, and wherein the set top box is further configured to read the support center identifier from the content being displayed.

33. The system of claim 32, wherein the support center identifier comprises a network address.

34. The system of claim 33, wherein the network address is one of a uniform resource locator (URL), an Internet protocol (IP) address, a telephone number, and a media access control (MAC) address.

35. The system of claim 26, wherein the remote control device comprises a microphone for capturing an audio signal for transmission to the support center and a speaker for generating audible output from an audio signal received from the support center.

36. The system of claim 26, wherein the set top box comprises a microphone for capturing an audio signal for transmission to the support center.

37. The system of claim 26, wherein the remote control device comprises a video camera for capturing a video signal for transmission to the support center.

38. The system of claim 26, wherein the set top box comprises a video camera for capturing a video signal for transmission to the support center.

39. The system of claim 26, wherein the set top box is further configured to establish a text-based, instant messaging session with the support center.

40 The system of claim 26, wherein the set top box is further configured to send a support request to an intermediate network node and receive therefrom an indication of a reserved communication channel for communication between the interactive television system and the support center.

41. The system of claim 40, wherein the intermediate network node comprises a head-end of a cable network.

42. The system of claim 40, wherein the intermediate network node comprises a central office (CO) of a telephone network.

43. The system of claim 40, wherein the communication channel comprises an Moving Picture Experts Group (MPEG) channel.

44. The system of claim 26, wherein the set top box is further configured to receive notification of a reserved communication channel from an intermediate network node.

45. The system of claim 44, wherein the notification of a reserved communication channel comprises a private indexing table.

46. The system of claim 26, wherein the set top box is further configured to display on a display device associated with the interactive television system a status indication pertaining to the support request.

47. The system of claim 46, wherein the status indication comprises at least one of:
an indication of a wait time;
an indication of a number of users waiting for a customer support request to be serviced;
an indication of the user's priority in a support queue;
an indication of a number of users in a support queue; and
an indication of a number of support technicians servicing customer support requests.
